(19) United States
(12) Patent Application Publication
(10) Pub. No.: US 2014/0349179 A1
(43) Pub. Date: Nov. 27, 2014

(54) SECONDARY BATTERY

(71) Applicant: Samsung SDl Co., LTD., Yongin-si (KR)

(72) Inventor: Kwan-Sic Chun, Yongin-si (KR)

(73) Assignee: Samsung SDl Co., LTD., Yongin-si (KR)

(21) Appl. No.: 14/255,203

(22) Filed: Apr. 17, 2014

(30) Foreign Application Priority Data
May 27, 2013 (KR) 10-2013-0059462

(51) Int. Cl. H01M 10/42

(52) U.S. Cl. CPC H01M 10/4235; H01M 2220/30
USPC 429/211

(57) ABSTRACT

A secondary battery includes a first electrode plate, a second electrode plate and a separator. The first electrode plate has a plurality of first active material coating portions formed by intermittently coating a first active material on a base material, and a first non-coating portion at which the first active material is not coated on the base material. The second electrode plate has a second active material coating portion formed by coating a second active material on a base material, and a second non-coating portion at which the second active material is not coated on the base material. The separator is interposed between the first and second electrode plates.

### CROSS-REFERENCE TO RELATED APPLICATIONS

This application claims priority to and the benefit of Korean Patent Application No. 10-2013-0059462, filed on May 27, 2013, in the Korean Intellectual Property Office, the entire contents of which are incorporated herein by reference in their entirety.

### BACKGROUND

1. Field

An aspect of the present invention relates to a secondary battery, and more particularly, to a secondary battery having improved safety.

2. Description of the Related Technology

In general, a secondary battery is a battery which can be charged and discharged plural times. As electrical, electronic, communication and computer industries are developed, demands for secondary batteries easily employed as power sources of portable devices have recently increased. As the type and amount of secondary batteries used are increased, studies have been conducted in many fields in order to improve the performance and safety of the secondary batteries.

Requirements of miniaturization and high capacity for a secondary battery are increased. The size of the secondary battery is increased in order to increase the capacity of the secondary battery but this affects the desire to simultaneously miniaturize the batteries. Further, the safety of a high-capacity secondary battery may be problematic. In a case where the secondary battery is used as a power source of an external electronic device, the secondary battery may cause a more serious problem due to the synergy effect of the external electronic device. Therefore, various studies are conducted to improve the safety of the secondary battery.

### SUMMARY OF CERTAIN INVENTIVE ASPECTS

Embodiments provide a secondary battery having improved safety.

Embodiments also provide a secondary battery having a new insulating member.

According to an aspect of the present invention, there is provided a secondary battery, including: a first electrode plate having a plurality of first active material coating portions formed by intermittently coating a first active material on a base material, and a first non-coating portion at which the first active material is not coated on the base material; a second electrode plate having a second active material coating portion formed by coating a second active material on a base material, and a second non-coating portion at which the second active material is not coated on the base material; and a separator interposed between the first and second electrode plates, wherein the first non-coating portion includes a first internal non-coating portion provided between the first active material coating portions adjacent to each other, wherein a first electrode tab and an insulating member provided to cover the first electrode tab are provided to the first internal non-coating portion, wherein the first electrode tab is protruded outward from the first internal non-coating portion so as to face a first direction, and the insulating member is provided to have an area wider than that of the first internal non-coating portion, wherein the insulating member is protruded outward from the first internal non-coating portion by a first length in the first direction, and is protruded outward from the first internal non-coating portion by a second length in a second direction opposite to the first direction, and wherein the first length is formed longer than the second length.

The insulating member may cover the first electrode tab so that the first electrode tab is exposed to 5 mm or more.

The first length may be extended to 0.5 to (d*0.1) mm in the first direction from an end of the first internal non-coating portion. The second length may be extended to 0.5 to (d*0.05) mm in the second direction from an end of the first internal non-coating portion. Here, d denotes the longitudinal length of the first electrode plate in a direction parallel with the first direction.

The internal non-coating portion may be divided into a first boundary portion adjacent to any one of the adjacent first active material coating portions and a second boundary portion adjacent to the other of the adjacent first active material coating portions. The first boundary portion may include a waveform.

The insulating member may be provided to cover the first and second boundary portions.

The insulating member may be provided to directly overlap with the first active material coating portions at the first and second boundary portions.

The maximum length between the adjacent first active material coating portions in a third direction perpendicular to the first direction from the first internal non-coating portion may be formed shorter than the length of the insulating member.

The first electrode plate may include a positive electrode plate, and the second electrode plate may include a negative electrode plate.

The first electrode plate may include first active material coating portions adjacent to each other, a first internal non-coating portion provided between the adjacent first active material coating portions, and first external non-coating portions respectively provided at outsides of the adjacent first active material coating portions. The second electrode plate may include one second active material coating portion, and second non-coating portions respectively provided at outsides of the second active material coating portion.

The area of the second active material coating portion of the second electrode plate may be formed to correspond to that including the adjacent first active material coating portions and the first internal non-coating portion.

The first electrode plate may include a positive electrode plate, and the second electrode plate may include a negative electrode plate.

The first electrode plate may include one first electrode tab provided to the first internal non-coating portion, and the second electrode plate may include second electrode tabs respectively provided to the two second non-coating portions.

The first electrode tab may be provided to protrude in the first direction, and the two second electrode tabs may be provided to protrude in the second direction so as to be parallel with each other

The first or second electrode tab may include copper (Cu) or Cu alloy.

The insulating member may include at least one of polyethylene (PE), polyimide (PI), polyethylene terephthalate (PET) and polyphenylene sulfide (PPS).

As described above, according to the present invention, it is possible to provide a secondary battery having improved safety.

Further, it is possible to provide a secondary battery having a new insulating member.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of a secondary battery according to an embodiment of the present invention.

FIG. 2A is a perspective view of an electrode assembly provided inside the secondary battery shown in FIG. 1.

FIG. 2B is an exploded perspective view of the electrode assembly shown in FIG. 2A.

FIG. 3A is a perspective view showing a first electrode plate and a second electrode plate according an embodiment of the present invention.

FIG. 3B is a perspective view showing the first electrode plate and an insulating member, shown in FIG. 3A.

FIGS. 4A, 4B, 4C and 4D show states in which insulating members are respectively provided to first electrode plates of Comparative Examples 1 to 3 and Embodiment 1, respectively.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

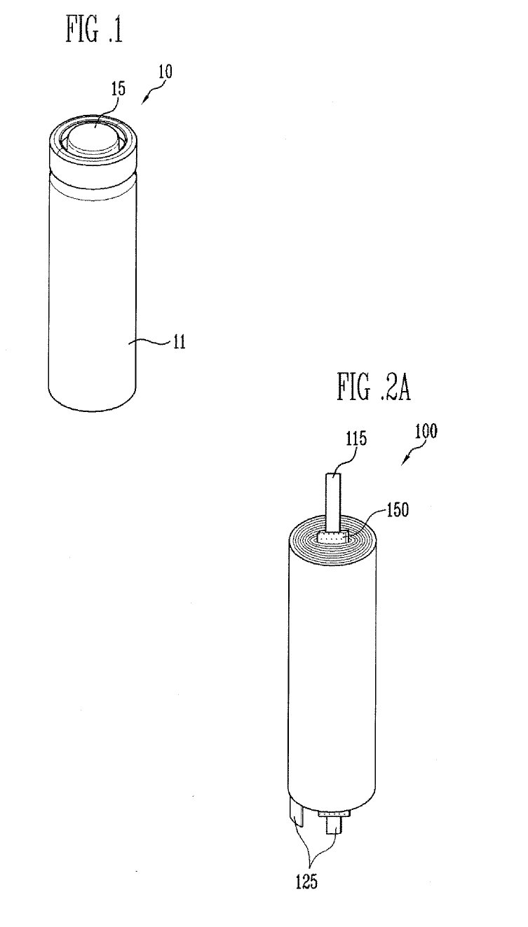

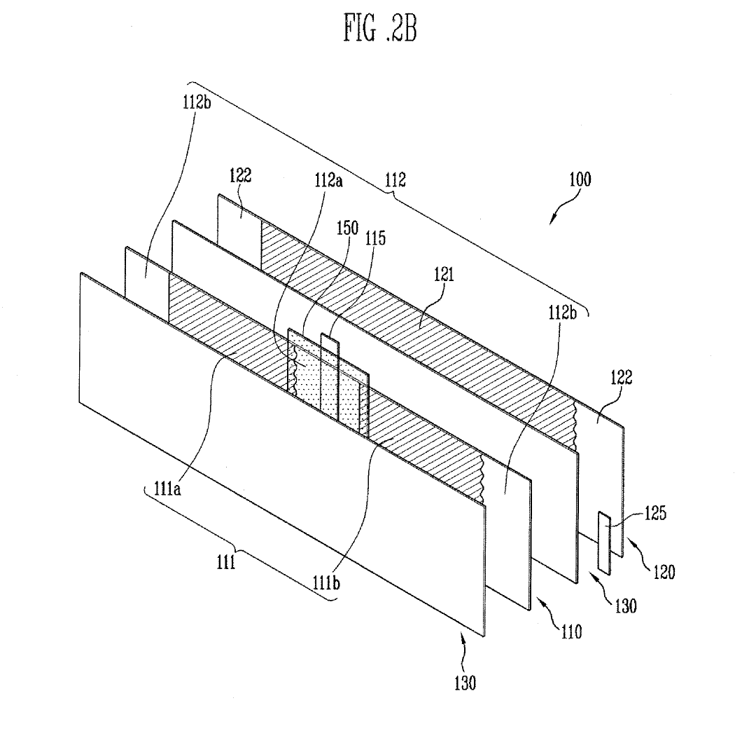

FIG. 1 is a perspective view of a secondary battery according to an embodiment of the present invention. FIG. 2A is a perspective view of an electrode assembly provided inside the secondary battery shown in FIG. 1. FIG. 2B is an exploded perspective view of the electrode assembly shown in FIG. 2A.

Referring to FIGS. 1, 2A and 2B, the secondary battery according to this embodiment may include an electrode assembly 100 and a battery case 11 and 15 configured to accommodate the electrode assembly 100 therein. The electrode assembly 100 may include a first electrode plate 110 having a plurality of first active material coating portions 111 formed by intermittently coating a first active material on a base material, and a first non-coating portion 112 at which the first active material is not coated on the base material; a second electrode plate 120 having a second active material coating portion 121 formed by coating a second active material on a base material, and a second non-coating portion at which the second active material is not coated on the base material; and a separator 130 interposed between the first and second electrode plates 110 and 120. The first non-coating portion 112 includes a first internal non-coating portion 112a provided between adjacent first active material coating portions 111a and 111b. A first electrode tab 115 and an insulating member 150 formed to cover the first electrode tab 115 are provided to the first internal non-coating portion 112a. The first electrode tab 115 is protruded toward the outside of the first internal non-coating portion 112a so as to face a first direction, and the insulating member 150 is provided to have an area wider than that of the first internal non-coating portion 112a. In this case, the insulation member 150 may be protruded outward from the first internal non-coating portion 112a by a first length in the first direction. The insulating member 150 may be protruded outward from the first internal non-coating portion 112a by a second length in a second direction opposite to the first direction. The first length may be formed longer than the second length. For example, the insulating member 150 may include a tape made of any one or more of polyethylene (PE), polyimide (PI), polyethylene terephthalate (PET) and polyphenylene sulfide (PPS).

The battery case 11 and 15 may include a main body 11 having one opened surface so as to accommodate the electrode assembly 100 and an electrolyte therein, and a cap assembly 15. For example, the cap assembly 15 is connected to the first electrode tab 115 of the first electrode plate 110, and the main body 11 is connected to a second electrode tab 125 of the second electrode plate 120, so that the cap assembly 15 and the main body 11 have different polarities. The main body 11 and the cap assembly 15 may be insulated by an insulator such as a gasket.

The electrolyte may be provided so that current easily flows between the first and second electrode plates 110 and 120. The electrolyte may include a lithium salt that acts as a supply source of lithium ions, and a non-aqueous organic solvent that serves as a medium through which ions participating in an electrochemical reaction can be moved.

The first electrode plate 110 may be a positive electrode plate, and the first active material may include a positive electrode active material such as lithium. The second active material may include a negative electrode active material such as carbon. The separator 130 may be interposed between the first and second electrode plates 110 and 120. The separator 130 becomes a passage of ions, and simultaneously, prevents the first and second electrode plates 110 and 120 from coming in direct contact with each other, thereby preventing the occurrence of a short circuit.

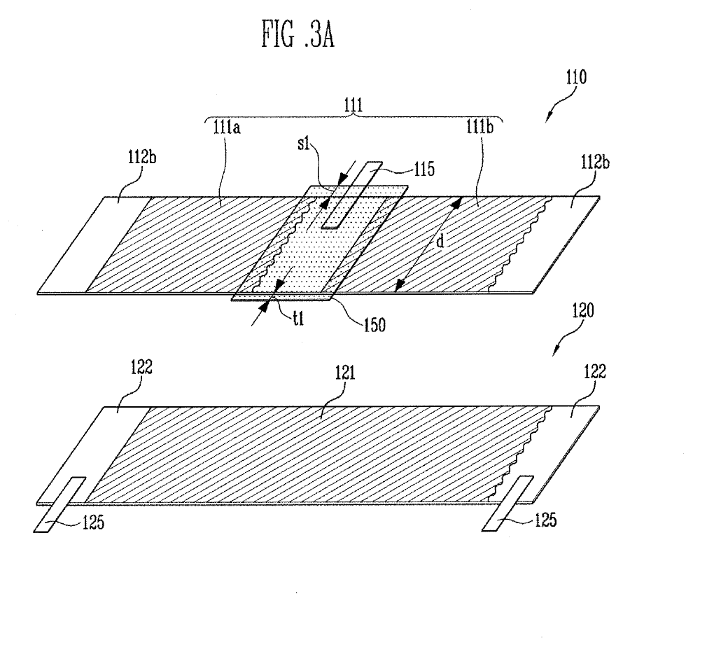

FIG. 3A is a perspective view showing the first electrode plate and the second electrode plate according an embodiment of the present invention. FIG. 3B is a perspective view showing the first electrode plate and the insulating member, shown in FIG. 3A.

Referring to FIGS. 3A and 3B, the first electrode plate 110 may include adjacent first active material coating portions 111a and 111b, a first internal non-coating portion 112a provided between the adjacent first active material coating portions 111a and 111b, and first external non-coating portions 112b respectively provided at outsides of the adjacent first active material coating portions 111a and 111b. The second electrode plate 120 may include one second active material coating portion 121, and second non-coating portions 122 respectively provided at outsides of the second active material coating portion 121. The first electrode plate 110 may include two or more first active material coating portions 111 and at least one first internal non-coating portion 112a. The area of the second active material coating portion 121 of the second electrode plate 120 may be provided to correspond to the area of the adjacent first active material coating portions 111a and 111b and the first internal non-coating portion 112a. For convenience of illustration, it has been described in this embodiment that the first electrode plate 110 includes two first active material coating portions 111 and one first internal non-coating portion 112a. However, the number of first active material coating portions 111 and the number of first internal non-coating portions 112a are not limited thereto.

The first electrode plate 110 may include one first electrode tab 115 provided to the first internal non-coating portion 112a, and the second electrode plate 120 may include second electrode tabs 125 respectively provided to the two second non-coating portions 122. The second electrode tab 125 may be provided to any one of the second non-coating portions 122. The first electrode tab 115 is provided to protrude in the first direction, and the two second electrode tabs 125 are protruded in parallel with each other. In this case, the two second electrode tabs 125 may be provided to protrude in the second direction. As described above, the first and second directions may be directions opposite to each other. For example, in a case where the first direction faces the cap assembly 15 (see FIG. 1) of the secondary battery, the second direction may face the bottom surface of the main body 11 (see FIG. 1) of the secondary battery. In this case, the first electrode tab 115 may be connected to the cap assembly, and the second electrode tab 125 may be connected to the main body. For example, the first or second electrode tab 115 or 125 may include copper (Cu) and Cu alloy.

Generally, a first electrode tab is made of aluminum (Al), and a second electrode tab is made of nickel (Ni). In a case where the first or second electrode tab formed using Al or Ni is provided inside the first or second electrode plate in a high-capacity secondary battery, a separator adjacent to the first or second electrode tab is melted when high current flows through the secondary battery, which causes an internal short circuit. Therefore, the safety of the secondary battery is problematic.

On the other hand, in the secondary battery according to this embodiment, the first or second electrode tab may be made of Cu or Cu alloy. Since the Cu or Cu alloy has excellent conductivity and low heat generation resistance as compared with Al or Ni, it is possible to prevent melting of the separator, etc. Thus, in a case where the secondary battery is a high-capacity secondary battery, the secondary battery can be safely used regardless of the position of the first or second electrode tab.

The first or second electrode plate 110 or 120 may form a first or second active material coating portion 111 or 121 and a first or second non-coating portion 112 or 122 on a base material by coating a first or second active material on the base material, using a coater or the like. Specifically, the base material continuously passes through the coater, so that the first or second active material coating portion 111 or 121 can be formed by the first or second active material discharged from the coater. In this case, any one of boundaries of the first and second active material coating portions is not formed in the shape of an approximately straight line but may be formed in the shape of a waveform attracted by the viscosity between the first or second active material and the base material.

The first internal non-coating portion 112a is divided into a first boundary portion 113a adjacent to one side of the adjacent first active material coating portions 111a and 111b, and a second boundary portion 113b adjacent to the other side of the adjacent first active material coating portions 111a and 111b. The first boundary portion 113a may include a waveform. For example, while one side of the first active material coating portion 111a of the adjacent first active material coating portions 111a and 111b, which is provided at the left side on the first electrode plate 110, has a boundary portion formed in the shape of an approximately straight line, the other side of the first active material coating portion 111a has a boundary portion formed in the shape of a waveform. Similarly, while one side of the first active material coating portion 111b of the adjacent first active material coating portions 111a and 111, which is provided at the right side on the first electrode plate 110, has a boundary portion formed in the shape of an approximately straight line, the other side of the first active material coating portion 111b has a boundary portion formed in the shape of a waveform. Thus, the shapes of the straight line and the waveform can be alternately provided at the boundary portions provided by the first active material coating portions 111 on the first electrode plate 110, and the first internal non-coating portion 112a can be provided between the waveform-shaped first boundary portion 113a and the straight line-shaped second boundary portion 113b. In this case, the insulation member 150 may be provided to cover the first and second boundary portions 113a and 113b. On the other hand, the left and right sides of the boundary portion may be changed by the direction in which the coating of the first or second active material is performed, but the present invention is not limited thereto. Hereinafter, for convenience of illustration, the boundary portion formed in the shape of a waveform is referred to as a first boundary portion, and the boundary portion formed in the shape of an approximately straight line is referred to a second boundary portion.

For example, the insulating member 150 covers the first and second boundary portions 113a and 113b. In this case, the portion at which the insulating member 150 overlaps with the first active material coating portion 111a or 111b may be provided to be 10 mm or less in a direction perpendicular to the first direction. In this case, the portion at which the insulating member 150 overlaps with the first active material coating portion 111a or 111b does not contribute to the capacity of the secondary battery. However, in a case where the overlapping portion exceeds 10 mm, the reduction in the capacity of the secondary battery is increased, and therefore, the efficiency of the secondary battery may be lowered.

The insulating member 150 covers the first and second boundary portions 113a and 113b. In this case, the insulating member 150 may directly overlap with the first active material coating portions 111a and 111b. In a case where the first electrode plate 110 is wound, the adhesion between the first active material and the base material is relatively low at the first and second boundary portions 113a and 113b, and therefore, the first active material may come off from the base material. In a case where the first active material coming off from the base material contacts the second electrode plate 120, the short circuit between the first and second electrode plates 110 and 120 may occur. Therefore, laminating may be performed by providing a separate tape on the first or second boundary portion 113a or 113b or covering the first or second boundary portion 113a or 113b, using resin or the like. In this case, the laminating prevents the first active material from coming off from the first or second boundary portion 113a or 113b. On the other hand, in this embodiment, the insulating member 150 may be provided to cover, together with the first electrode tab 115, the first and second boundary portions 113a and 113b. Thus, the laminating can be omitted at the boundary portions 113a and 113b, thereby reducing production cost and improving process efficiency. That is, in the secondary battery according to this embodiment, the insulating member 150 covering the first electrode tab 115 can be provided to cover both the first and second boundary portions 113a and 113b without adding a separate member such as the laminating for preventing the base material from coming off from the first and second boundary portions 113a and 113b.

The first electrode tab 115 and the insulating member 150 may be provided to the first internal non-coating portion 112a. Here, the first electrode tab 115 may be protruded toward the outside of the first internal non-coating portion 112a so as to face the first direction, and the insulating member 150 may be provided to have an area wider than that of the first internal non-coating portion 112a. In this case, the insulating member 150 may cover the first electrode tab 115 so that the first electrode tab 115 is exposed to 5 mm or more. The first electrode tab 115 may be protruded outward from the first internal non-coating portion 112a, so as to be electrically connected to the cap assembly through welding or the like. In a case where the portion at which the first electrode tab 115 is exposed from the insulating member 150 is less than 5 mm, the insulating member 150 is welded together with the first electrode tab 115, and therefore, a failure between the first electrode tab 115 and the cap assembly may occur. Further, the insulating member 150 may be damaged by heat generated in the welding. Accordingly, the portion at which the insulating member 150 does not cover the first electrode tab 115 is preferably 5 mm or more from the portion at which the electrode tab 115 is protruded outward from the first internal non-coating portion 112a.

The longitudinal length v1 of the insulating member 150 in a direction parallel with the first direction may be formed longer than that d of the first electrode plate 110. The maximum length u2 between the adjacent first active material coating portions 111a and 111b in a third direction perpendicular to the first direction may be formed shorter than that u1 of the insulating member 150. As described above, the first boundary portion 113 may be formed in the shape of a waveform, and the second boundary portion 113b may be formed in the shape of a straight line. In this case, the maximum length u2 between the adjacent first active material coating portions 111a and 111b is based on the portion maximally recessed toward the first active material coating portion 111a at the first boundary portion 113a. The maximum length u2 between the adjacent first active material coating portions 111a and 111b may mean the longest distance among straight line distances between the adjacent first active material coating portions 111a and 111b.

The insulating member 150 may be protruded outward from the first internal non-coating portion 112a by a first length s1 in the first direction, and may be provided to the outside of the first internal non-coating portion 112a by a second length t1 in the second direction opposite to the first direction. The first length s1 may be formed longer than the second length t1. In a case where the electrode assembly 100 (see FIG. 2A) is manufactured by winding the first electrode plate 110, the second electrode plate 120 and the separator 130 interposed between the first and second electrode plates 110 and 120, and then mounted in the main body of the battery case, the first length S1 may face the cap assembly, and the second length t1 may face the bottom surface of the main body. The first electrode tab 115 may face the first direction so as to be electrically connected to the cap assembly 15 (see FIG. 1), and the second electrode tab 125 may face the second direction so as to be electrically connected to the bottom surface of the main body 11 (see FIG. 1).

In this case, the cap assembly may have a plurality of members such as a safety member, and the main body may be sealed with the cap assembly through a process including clamping, etc. Thus, the secondary battery can be manufactured with a predetermined spatial assembling tolerance between the electrode assembly and the cap assembly, which provides a spatial room in which the first length s1 of the insulating member 150 is formed. On the other hand, the electrode assembly and the bottom surface of the main body come in direct contact with each other without providing a separate member or the like to the bottom surface of the main body between the electrode assembly and the main body. Therefore, in a case where an unnecessarily separated space exists between the electrode assembly and the bottom surface of the main body, a decrease in capacity per unit volume is caused. In a case where the second length t1 is formed to a predetermined value or more, the spacing distance between the electrode assembly and the bottom surface of the main body is long, and therefore, a failure in the welding between the second electrode and the bottom surface of the main body may occur. In addition, the electrode assembly is not stably fixed inside the main body, and therefore, the electrode assembly may be moved by an external force such as falling. Accordingly, the second length t1 of the insulating member 150 is preferably formed shorter than the first length s1.

For example, the first length s1 and the second length t1 may be determined by the longitudinal length d of the first electrode plate. In this case, the first length s1 may be extended in the first direction from an end of the first internal non-coating portion 112a by 0.5 mm to (d*0.1) mm, and the second length t1 may be extended in the second direction from an end of the first internal non-coating portion 112a by 0.5 mm to (d*0.05) mm (here, d denotes the longitudinal length of the first electrode plate in the direction parallel with the first direction). In a case where the first length s1 is less than 0.5 mm, the first electrode plate 110 is expanded in a process of charging the secondary battery, and therefore, the first internal non-coating portion 112a may be protruded outward from the insulating member 150. Further, the separator is melted by high current flowing in the first electrode tab 115 of the first electrode plate 110, and therefore, an internal short circuit may occur. In a case where the first length s1 exceeds (d*0.1) mm, the insulating member 150 interrupts the welding between the first electrode tab 115 and the cap assembly, or an adhesive provided to the insulating member 150 interrupts the winding of the first and second electrodes 110 and 120. Therefore, the electrode assembly may be deformed. In a case where the second length t1 is less than 0.5 mm, the first internal non-coating portion 112a may be protruded outward from the insulating member 150 by the expansion of the first electrode plate 110 in the welding. In a case where the second length t1 exceeds (d*0.05) mm, the insulating member 150 interrupts the welding between the second electrode tab 125 and the main body, and the electrode assembly is not stably fixed in the main body. Therefore, the electrode assembly may be moved by an external force, etc.

Hereinafter, an embodiment of the present invention and comparative examples are described. However, the following embodiment is merely one exemplary embodiment of the present invention, and the scope of the present invention is not limited to the following embodiment.

In an electrode assembly including a first electrode plate (positive electrode plate), a second electrode plate (negative electrode plate) and a separator, only an insulating member provided to the first electrode plate was changed, thereby manufacturing secondary batteries according to the following Comparative Examples 1 to 3 and Embodiment 1. Here, a first electrode tab was provided to a first internal non-coating portion between adjacent two first active material coating portions on the first electrode plate, and second electrode tabs were respectively provided to two second non-coating portions provided at outsides of one second active material coating portion. The electrode assembly was manufactured by interposing the separator between the first and second electrode plates and then winding the first and second electrode plates and the separator. The electrode assembly and an electrolyte were accommodated in a battery case, thereby manufacturing a secondary battery. In Comparative Examples 1 to 3 and Embodiment 1, separate laminating was not performed at first and second boundary portions that distinguish the first active material coating portions from the first internal non-coating portion.

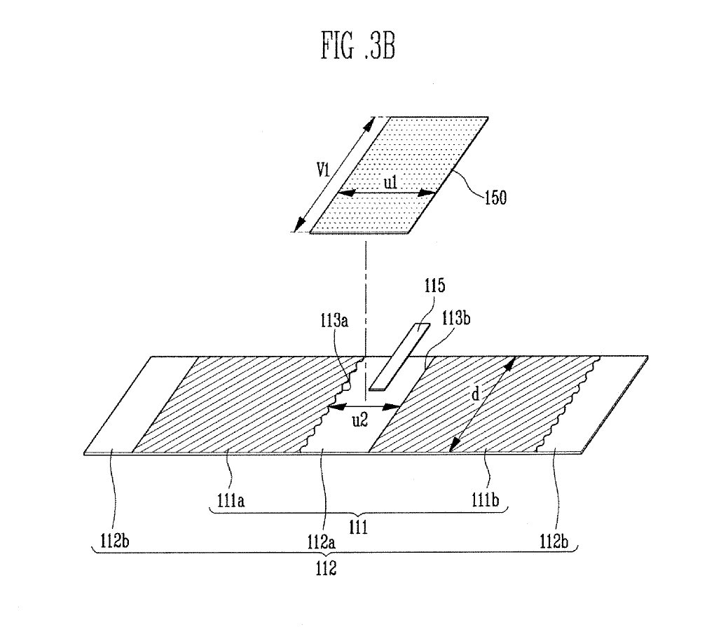

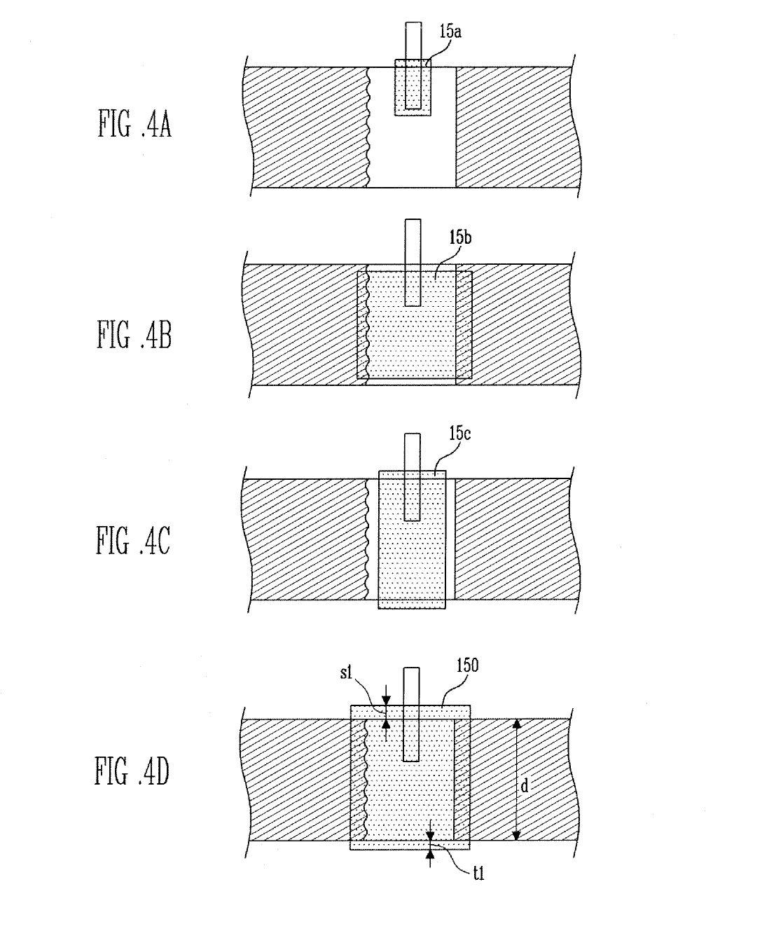

FIG. 4 schematically shows states in which insulating members are respectively provided to the first electrode plates of Comparative Examples 1 to 3 and Embodiment 1, respectively. In Comparative example 1, an insulating member 15a was provided to cover only a portion of the first electrode tab in the first internal non-coating portion as shown in FIG. 4(a). In Comparative Example 2, an insulating member 15b covered the first and second boundary portions in the first internal non-coating portion so as not to protrude in first and second directions (upper and lower portions) of the first internal non-coating portion as shown in FIG. 4(b). In Comparative Example 3, an insulating member 15c was protruded in the first and second directions of the first internal non-coating portion so as not to cover the first and second boundary portions as shown in FIG. 4(c). In Embodiment 1, an insulating member 150 was provided greater than the first internal non-coating portion so as to cover the first and second boundary portions and to protrude in the first and second directions from an end of the first internal non-coating portion as shown in FIG. 4(d). In Embodiment 1, the first length s1 of the insulating member 150, protruded in the first direction, was 10 mm, and the second length t1 of the insulating member 150, protruded in the second direction, was 5 mm. In Embodiment 1, the first length s1 was formed longer than the second length t1. In this case, the longitudinal length d of the first electrode plate in the first direction was 60 mm. Therefore, the first length s1 satisfied a range of 0.5 to (d*0.1) mm, and the second length t1 satisfied a range of 0.5 to (d*0.05) mm.

10 secondary batteries manufactured as described above were prepared in each of Comparative Examples 1 to 3 and Embodiment 1. The prepared secondary batteries were fully charged to be constant current-constant voltage (CC-CV) up to 4.2V at 1 C (2 A), using a charger/discharger. Short circuit and heat exposure tests were performed on the secondary batteries (10 for each, a total of 40) according to Comparative Examples 1 to 3 and Embodiment 1.

In the short circuit test, 5 fully charged secondary batteries were prepared in each of Comparative Examples 1 to 3 and Embodiment 1, and a short circuit was then caused by contacting positive and negative electrodes of each secondary battery, using a copper wire of which maximum resistance was 0.11 at a normal temperature. Results of the short circuit test were shown in Table 1. In Table 1, a case where the secondary battery was fired or exploded was represented as false (NG), and a case where the secondary battery was fully discharged and the temperature of the secondary battery approached the normal temperature was represented as satisfactory (OK).

In the heat exposure test, five fully charged secondary batteries were prepared in each of Comparative Examples 1 to 3 and Embodiment 1 and then left in a chamber at 150° C. for 10 minutes. Results of the heat exposure test were shown in Table 1. In Table 1, a case where the secondary battery was fired or exploded was represented as false (NG), and a case where the secondary battery was fully discharged and the temperature of the secondary battery approached the normal temperature was represented as satisfactory (OK).

TABLE 1

| | |
|---|---|
| Short Circuit | Heat Exposure |
| Test | Test |

| | NG | OK | NG | OK |
|---|---|---|---|---|
| Comparative Example 1 | 5 | 0 | 5 | 0 |
| Comparative Example 2 | 5 | 0 | 3 | 2 |
| Comparative Example 3 | 3 | 2 | 4 | 1 |
| Embodiment 1 | 0 | 5 | 0 | 5 |

In Comparative Example 1, it can be seen that all the five secondary batteries subjected to the short circuit test and the five secondary batteries subjected to the heat exposure test obtain the result of NG. In Comparative Example 1, all the five secondary batteries subjected to the heat exposure test obtained the result of explosion other than simple firing. In Comparative example 1, it can be seen that first active materials at the first and second boundary portions come off from the base material in the process of manufacturing the electrode assembly by winding the first and second electrode plates. In this case, the first active material more easily came off at a boundary portion formed in the shape of a waveform in the first and second boundary portions. As a result in which the secondary battery of Comparative Example 1 is disassembled after the short circuit test, it can be seen that the separator is melted at the first internal non-coating portion.

In Comparative Example 2, it can be seen that the five secondary batteries subjected to the short circuit test obtain the result of NG, and only three secondary batteries subjected to the heat exposure test obtain the result of NG. In Comparative Example 2, the insulating member covered the first and second boundary portions, and thus the first active material did not come off in the process of winding the first and second electrode plates. On the other hand, as a result in which the secondary battery of Comparative example 2 is disassembled after the short circuit test, it can be seen that the separator is melted.

In Comparative Example 3, it can be seen that three secondary batteries subjected to the short circuit test obtain the result of NG, and four secondary batteries subjected to the heat exposure test obtain the result of NG. In a case where the first and second electrode plates of Comparative Example 3, a portion of the first active material came off. On the other hand, as a result in which the secondary battery of Comparative example 3 is disassembled after the short circuit test, it can be seen that the melting of the separator is decreased as compared with Comparative Examples 1 and 2.

In Embodiment 1, it can be seen that all the five secondary batteries subjected to the short circuit test and the five secondary batteries subjected to the heat exposure test obtain the result of OK. While the first and second electrode plates of Embodiment 1 were being wound, the first active material did not come off at the first and second boundary portions. As a result in which the secondary battery of Embodiment 1 is disassembled after the short circuit test, it can be seen that the separator is not melted.

That is, in Embodiment 1, it can be seen that the first active material does not come off in the process of winding the first electrode plate without performing separate laminating. Further, it can be seen that satisfactory results are obtained in both the short circuit test and the heat exposure test, and thus Embodiment 1 can have safety superior to that of Comparative Examples 1 to 3. As a result in which the secondary battery is disassembled after the short circuit test, it can be seen that the separator is melted in Comparative Examples 1 to 3. On the other hand, it can be seen that the separator is not melted in Embodiment 1.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a first electrode plate having a plurality of first active material coating portions formed by intermittently coating a first active material on a base material, and a first non-coating portion at which the first active material is not coated on the base material;
a second electrode plate having a second active material coating portion formed by coating a second active material on a base material, and a second non-coating portion at which the second active material is not coated on the base material; and
a separator interposed between the first and second electrode plates,
wherein the first non-coating portion includes a first internal non-coating portion provided between the first active material coating portions adjacent to each other,
wherein a first electrode tab and an insulating member provided to cover the first electrode tab are provided to the first internal non-coating portion,
wherein the first electrode tab is protruded outward from the first internal non-coating portion so as to face a first direction, and the insulating member is provided to have an area wider than that of the first internal non-coating portion,
wherein the insulating member is protruded outward from the first internal non-coating portion by a first length in the first direction, and is protruded outward from the first internal non-coating portion by a second length in a second direction opposite to the first direction, and
wherein the first length is formed longer than the second length.

2. The secondary battery of claim 1, wherein the insulating member covers the first electrode tab so that the first electrode tab is exposed to 5 mm or more.

3. The secondary battery of claim 1, wherein the first length is extended to 0.5 to (d*0.1) mm in the first direction from an end of the first internal non-coating portion wherein d denotes the longitudinal length of the first electrode plate in a direction parallel with the first direction.

4. The secondary battery of claim 1, wherein the second length is extended to 0.5 to (d*0.05) mm in the second direction from an end of the first internal non-coating portion wherein d denotes the longitudinal length of the first electrode plate in a direction parallel with the first direction.

5. The secondary battery of claim 1, wherein the first internal non-coating portion is divided into a first boundary portion adjacent to any one of the adjacent first active material coating portions and a second boundary portion adjacent to the other of the adjacent first active material coating portions, and the first boundary portion includes a waveform.

6. The secondary battery of claim 5, wherein the insulating member is provided to cover the first and second boundary portions.

7. The secondary battery of claim 6, wherein the insulating member is provided to directly overlap with the first active material coating portions at the first and second boundary portions.

8. The secondary battery of claim 1, wherein the maximum length between the adjacent first active material coating portions in a third direction perpendicular to the first direction from the first internal non-coating portion is formed shorter than the length of the insulating member.

9. The secondary battery of claim 1, wherein the first electrode plate includes a positive electrode plate, and the second electrode plate includes a negative electrode plate.

10. The secondary battery of claim 9,
wherein the first electrode plate includes first active material coating portions adjacent to each other, a first internal non-coating portion provided between the adjacent first active material coating portions, and first external non-coating portions respectively provided at outsides of the adjacent first active material coating portions, and
wherein the second electrode plate includes one second active material coating portion, and second non-coating portions respectively provided at outsides of the second active material coating portion.

11. The secondary battery of claim 10, wherein the area of the second active material coating portion of the second electrode plate is formed to correspond to that including the adjacent first active material coating portions and the first internal non-coating portion.

12. The secondary battery of claim 10, wherein the first electrode plate includes one first electrode tab provided to the first internal non-coating portion, and the second electrode plate includes second electrode tabs respectively provided to the two second non-coating portions.

13. The secondary battery of claim 12, wherein the first electrode tab is provided to protrude in the first direction, and the two second electrode tabs are provided to protrude in the second direction so as to be parallel with each other.

14. The secondary battery of claim 1, wherein the first or second electrode tab includes copper (Cu) or Cu alloy.

15. The secondary battery of claim 1, wherein the insulating member includes at least one of polyethylene (PE), polyimide (PI), polyethylene terephthalate (PET) and polyphenylene sulfide (PPS).

16. A secondary battery, comprising:
a first electrode plate having a plurality of first active material coating portions formed by intermittently coating a first active material on a base material, and a first non-coating portion at which the first active material is not coated on the base material;
a second electrode plate having a second active material coating portion formed by coating a second active material on a base material, and a second non-coating portion at which the second active material is not coated on the base material; and
a separator interposed between the first and second electrode plates,
wherein the first non-coating portion is positioned between the first active material coating portions adjacent to each other so define a first internal non-coating portion,
wherein a first electrode tab and an insulating member provided to cover the first electrode tab are provided to the first internal non-coating portion,
wherein the first electrode tab is protruded outward from the first internal non-coating portion so as to face a first direction, and the insulating member is provided to have an area wider than that of the first internal non-coating portion,
wherein the insulating member is protruded outward from the first internal non-coating portion by a first length in the first direction, and is protruded outward from the first internal non-coating portion by a second length in a second direction opposite to the first direction, and
wherein the first length is formed longer than the second length.

17. The secondary battery of claim 16, wherein the first non-coating portion includes the first internal non-coating portion and other non-coating portions.

18. The secondary battery of claim 17, wherein the first internal non-coating portion is divided into a first boundary portion adjacent to any one of the adjacent first active material coating portions and a second boundary portion adjacent to the other of the adjacent first active material coating portions, and the first boundary portion includes a waveform.

19. The secondary battery of claim 18, wherein the insulating member is provided to cover the first and second boundary portions.

20. The secondary battery of claim 19, wherein the insulating member is provided to directly overlap with the first active material coating portions at the first and second boundary portions.
